(19) United States
(12) Patent Application Publication
(10) Pub. No.: US 2008/0049083 A1
(43) Pub. Date: Feb. 28, 2008

(54) Liquid container

(75) Inventors: Taku Ishizawa, Shiojiri-shi (JP); Satoshi Shinada, Shiojiri-shi (JP); Fuminori Doi, Shiojiri-shi (JP); Sota Yamamoto, Matsumoto-shi (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation, Shinjuku-ku (JP)

(21) Appl. No.: 11/889,247

(22) Filed: Aug. 10, 2007

(30) Foreign Application Priority Data
Aug. 12, 2006 (JP) 2006-220758
Aug. 3, 2007 (JP) 2007-203349

(51) Int. Cl. B41J 2/175

(52) U.S. Cl. 347/86

(57) ABSTRACT

A liquid container capable of determining whether ink is filled into a correct liquid container in a liquid-filling process, when there are products having the same misinsertion preventing shapes but different liquid capacities, is provided.

A liquid container 11 is detachably mounted on a liquid ejecting apparatus 13 and has a side face parallel to a fitting direction of a container body 31. The liquid container 11 includes a fittingness-determination portion that extends in the fitting direction and enables fittingness determination depending on a position thereof in a direction perpendicular to the fitting direction, and a filling-determination portion that is formed at the fittingness-determination portion and enables determination of the amount of liquid to be filled in the container body 31.

### BACKGROUND OF THE INVENTION

1. Field of the Invention

The present invention relates to a liquid container, and more specifically, to a liquid container having a fittingness-determination portion used for determining fittingness between the liquid container and a liquid ejecting apparatus when the liquid container is mounted to the liquid ejecting apparatus, and a filling-determination portion used for determining the capacity of the liquid container when the liquid container is filled with liquid.

2. Related Art Invention

Some color ink jet printers (liquid ejecting apparatuses) for color printing use ink cartridges (liquid containers), which are dedicated containers of ink, filled with different colors of ink, such as B (black), C (cyan), M (magenta), and Y (yellow). The ink (liquid) contained in the ink cartridges is supplied to a print head driven in response to printing data sent from a host computer. The ink is then ejected at a target position on a printing medium, such as a sheet of paper, from nozzles formed in the print head and corresponding to respective colors.

In recent years, in order to realize higher definition full-color printing, the color inks to be mounted on a printer include different shades of colors, for example, DY (dark yellow) and LC (light cyan), other than the aforementioned C (cyan), M (magenta), and Y (yellow). Thus, the number of ink cartridges to be mounted on a printer is increasing.

A printer has dedicated cartridge receptacles (container receptacles) corresponding to respective colors. When ink cartridges having the same external dimensions are employed, similar cartridge receptacles are aligned. As a result, a user may fit an ink cartridge in an incorrect position.

If an ink cartridge is mounted on a position for another color, ink near an ink supply hole in the cartridge and another color ink remaining near an ink supply needle of a printer are mixed. This may degrade printing quality.

By manufacturing a plurality of types of ink cartridges having substantially the same exteriors but containing different types of ink (for example, dye ink and pigment ink), the same components can be used in a dye printer and a pigment printer.

However, because the ink cartridges having substantially the same exteriors but containing different types of ink are sold, an ink cartridge of the incorrect ink type may be inserted into a printer. If a pigment-ink cartridge is inserted into a dye printer mistakenly, dye ink near the ink supply hole of the cartridge and pigment ink remaining near the ink supply needle of the printer are mixed. This may cause aggregation of the pigment and clogging in a head or the like.

Under the circumstances, a liquid container having misinsertion preventing means is proposed, which prevents an ink cartridge from being mounted on an incongruent cartridge receptacle (for example, refer to Patent Document 1).

Such a liquid container has an identifying portion provided in an ink tank corresponding to an identifying portion provided on a slot to be mounted with the ink tank. When a slot is inserted with a correct ink tank, an identification rib on the slot is inserted into an identification recess in the ink tank without an identification salient provided on the ink tank abutting onto the identification rib or the like. Thus, the ink tank can be inserted into the slot. In contrast, when a slot is about to be inserted with an incorrect ink tank, the identification rib abuts onto the identification salient, whereby insertion of the ink tank becomes impossible.

[Patent Document 1] JP-A-2002-234178

There are liquid containers having the misinsertion preventing means of the same shape but different ink capacities. The advantages of these are that, by manufacturing a plurality of types of ink cartridges containing different amounts of ink, a printer expected to perform a small volume of printing can be provided with a small-capacity ink cartridge whose price per unit is low, and a printer expected to perform a large volume of printing can be provided with a large-capacity ink cartridge whose ink price per gram is low.

However, if ink cartridges having substantially the same shape but different ink capacities are sold, an ink cartridge with incorrect capacity may be inserted into the printer.

For example, if a small-capacity ink cartridge is inserted into a large-capacity printer, the printer tries to continue printing even after the ink has been exhausted, leading to a possible failure of a head. In contrast, if a large-capacity ink cartridge is inserted into a small-capacity printer, the printer determines that the ink has been exhausted even though ink remains in the tank, leading to a possible problem in that a large amount of ink remains.

In order to prevent incorrect insertion associated with different ink capacities, a fittingness-determination portion and a filling-determination portion may be individually provided on a liquid container. However, this results in increases in combination patterns, area for forming the determination portions size of liquid containers, cost of fabricating molds, and consequently, product price.

Further, even when prevention of incorrect insertion associated with different ink capacities is not performed, there is a problem in that manufacturer cannot determine whether ink is filled into a liquid container of correct shape in an ink-filling process because the liquid containers have the misinsertion preventing means of the same shape.

### SUMMARY OF THE INVENTION

The invention has been made in view of the above-described situations, and it is an object of the invention to provide a liquid container capable of determining whether liquid is filled into a correct liquid container in a liquid-filling process, when there are products having the same misinsertion preventing shapes but different liquid capacities. The liquid container has determination portions formed on a small area. This simplifies a mold structure and reduces product price.

The above-described object of the invention may be achieved by a liquid container detachably mounted on a liquid ejecting apparatus and having a side face parallel to a mounting direction of the liquid container, the liquid container including a fittingness-determination portion that extends in the mounting direction and enables fittingness determination depending on a position thereof in a direction perpendicular to the mounting direction, and a filling-determination portion that is formed at the fittingness-determination portion and enables determination of the amount of liquid to be filled in the liquid container, the fittingness-determination portion and the filling-determination portion being formed on a single area of the side face.

According to the liquid container configured as above, when there are products having the same misinsertion preventing shapes (fittingness-determination portions) but different liquid capacities, whether liquid is filled into a correct liquid container can be detected in the liquid-filling process by detecting the filling-determination portion formed at the fittingness-determination portion.

Further, the liquid containers can be manufactured in different capacities using a single mold by replacing only an inset portion. By integrally forming the fittingness-determination portion and the filling-determination portion, these determination portions can be formed on a small single area, and all patterns of the determination portions can be formed by replacing the small inset portion of the mold.

It is desirable that, in the liquid container configured as above, the fittingness-determination portion constitute a ridge extending in the mounting direction,

and the filling-determination portion constitute a cutaway portion provided by removing a part of the fittingness-determination portion.

According to the liquid container configured as above, when the liquid container is about to be mounted on an incorrect container receptacle, an anterior end of the fittingness-determination portion abuts onto an inner wall of a fitting groove provided in the container receptacle and receives reaction force. However, because the fittingness-determination portion is extended in the insertion direction, the strength against the reaction force applied at that time can be increased. Accordingly, damages thereto can be suppressed.

Further, because the filling-determination portion is formed by removing a part of the fittingness-determination portion, a change in the shape of the container receptacle, which becomes necessary in the case of forming a projected filling-determination portion, for example, is not needed. Accordingly, a good fitting property can be maintained.

Further, the shape for forming the filling-determination portion needed to be formed on the inset of the mold can be simplified. That is, the inset has a simple shape in which a part thereof for forming a cutaway portion fills a part for forming a groove that forms the ridge.

Further, it is desirable that, in the liquid container configured as above, the cutaway portion be formed by removing the posterior end of the fittingness-determination portion in the fitting direction.

According to the liquid container configured as above, because the cutaway portion serving as the filling-determination portion is formed by removing the posterior end of the fittingness-determination portion in the fitting direction, the anterior end in the fitting direction remains. Because only the posterior end is removed, the determination function of the fittingness-determination portion is not degraded.

Further, it becomes easy to further increase patterns of determination performed by the filling-determination portion by changing the amount of removal from the posterior end to the anterior end.

Further, it is desirable that, in the liquid container configured as above, fittingness between the liquid container and different liquid ejecting apparatuses be determined.

According to the liquid container configured as above, in the case where there are a plurality of types of liquid containers containing different amounts of liquid, the plurality of types of liquid containers can be categorized into liquid containers appropriate for a specific liquid ejecting apparatus and liquid containers appropriate for another liquid ejecting apparatus (that is, allocation of a liquid container to an appropriate liquid ejecting apparatus becomes possible).

Further, it is desirable that, in the liquid container configured as above, fittingness between the liquid container and different container receptacles in a single liquid ejecting apparatus be determined.

According to the liquid container configured as above, in the case where there are a plurality of types of liquid containers containing different amounts of liquid (or colors), the plurality of types of liquid containers can be categorized into liquid containers appropriate for a specific container receptacle and liquid containers appropriate for another container receptacle (that is, allocation of a liquid container to an appropriate container receptacle becomes possible).

### BRIEF DESCRIPTION OF THE DRAWINGS

FIG. 1 is an external perspective view of a liquid ejecting apparatus to be mounted with a liquid container according to an embodiment of the invention.

FIG. 2 is an exploded perspective view of the liquid container shown in FIG. 1.

FIGS. 3(a), 3(b), and 3(c) are perspective views of liquid containers with different capacities.

FIGS. 4(a), 4(b), and 4(c) are back views of exemplary liquid containers having different determination portions.

FIGS. 5(a), 5(b), and 5(c) are schematic views of exemplary formations of determination portions.

FIG. 6 is a partially cutaway perspective view of a carriage shown in FIG. 1, in which only one ink cartridge is mounted.

FIG. 7 illustrates relationships between liquid containers and corresponding apparatuses to be mounted with the liquid containers.

11 . . . ink cartridge (liquid container), 13 . . . color ink jet printer (liquid ejecting apparatus), 23a, 23b, 23c . . . cartridge receptacle (container receptacle), 31A, 31B, 31C container body, 53 . . . back face (side face parallel to the fitting direction), 50 . . . ink (liquid), 55 . . . fittingness-determination portion, 57 . . . filling-determination portion, 59, 61 . . . ridge, 63 . . . cutaway portion

### DESCRIPTION OF THE PREFERRED EMBODIMENTS

Preferred embodiments of a liquid container according to the invention will now be described with reference to the drawings.

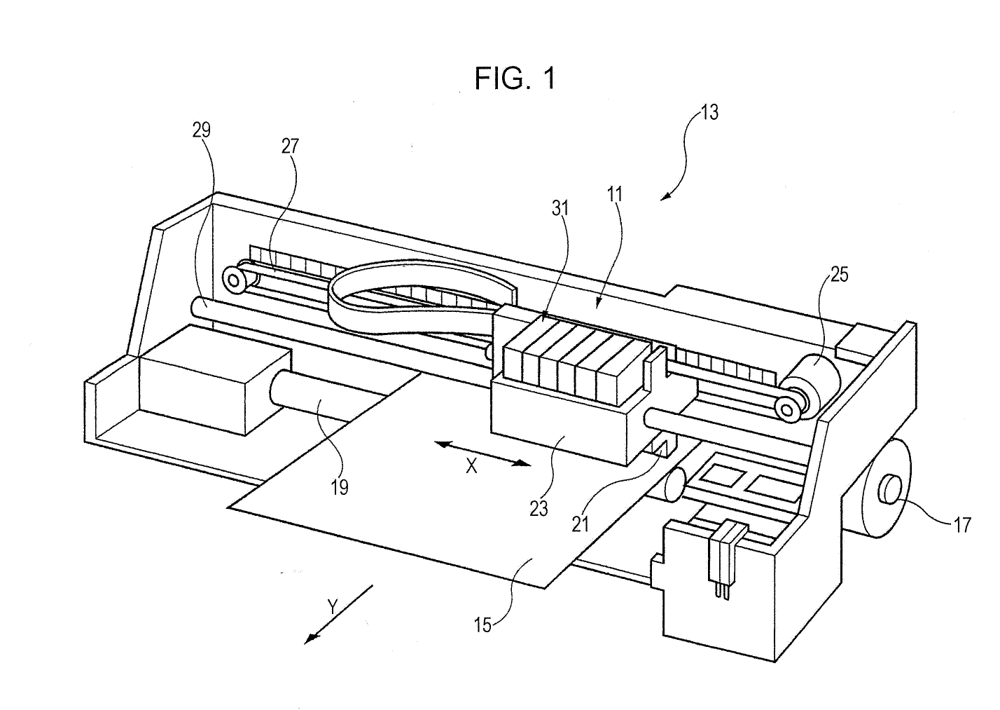

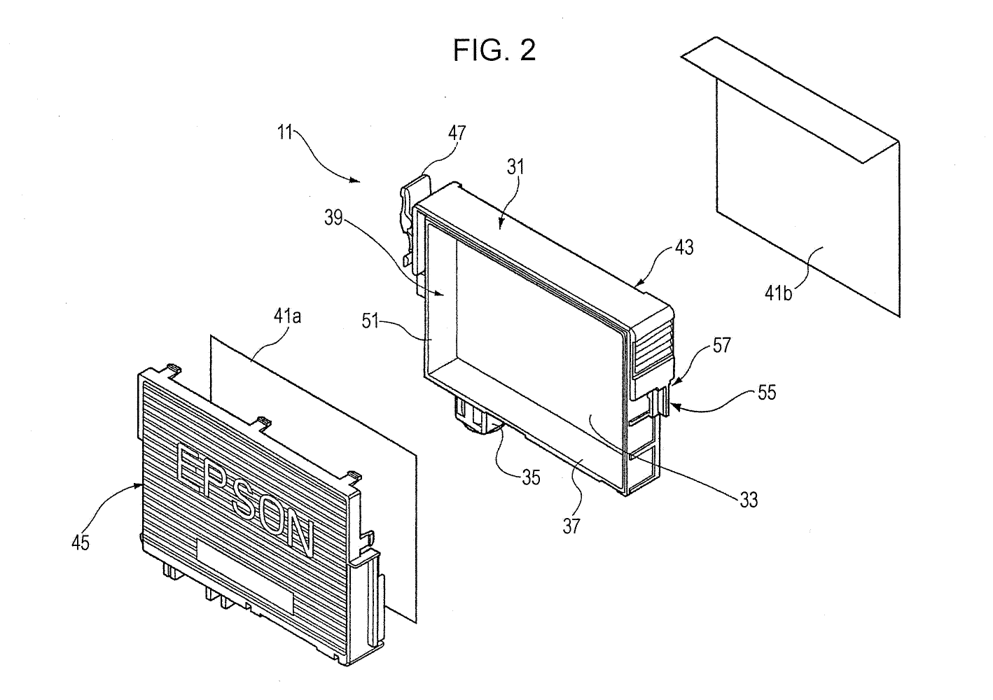

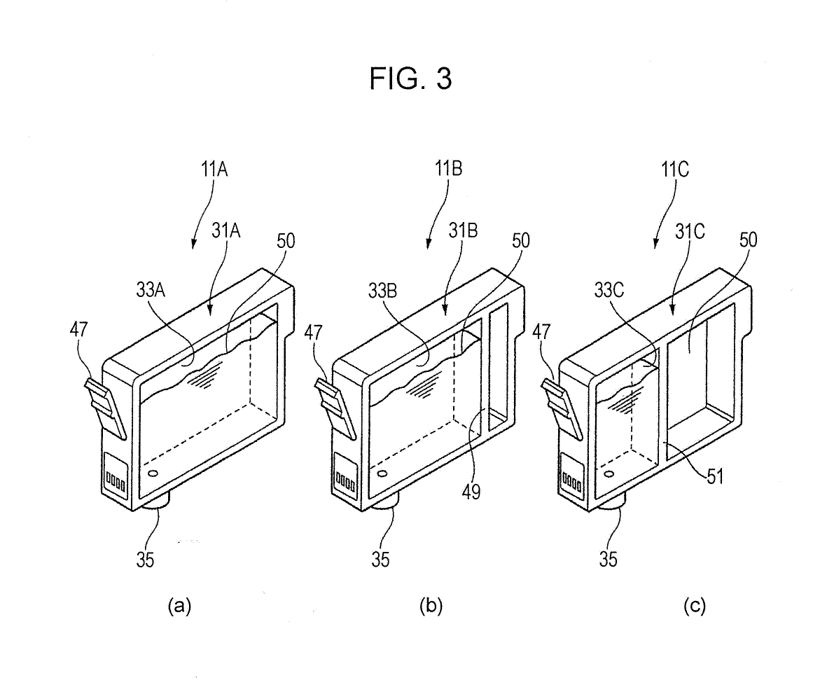

FIG. 1 is an external perspective view of a liquid ejecting apparatus to be mounted with a liquid container according to an embodiment of the invention. FIG. 2 is an exploded perspective view of the liquid container shown in FIG. 1. FIGS. 3(a), 3(b), and 3(c) are perspective views of liquid containers with different capacities.

As shown in FIG. 1, a color ink jet printer (liquid ejecting apparatus) 13 to be mounted with ink cartridges (liquid containers) 11 according to the embodiment includes, a paper feed motor 17 that transports recording paper 15 in a paper transporting direction Y, a platen 19, a carriage 23 having a print head (liquid eject head) 21, and a carriage motor 25 that reciprocates the carriage 23 in a paper width direction X.

The carriage 23 is pulled by a pulling belt 27 driven by the carriage motor 25 and moves along a guide rail 29. The carriage 23 are mounted with, other than the print head 21, the plurality of ink cartridges 11 containing ink (liquid) 50 to be supplied to the print head 21.

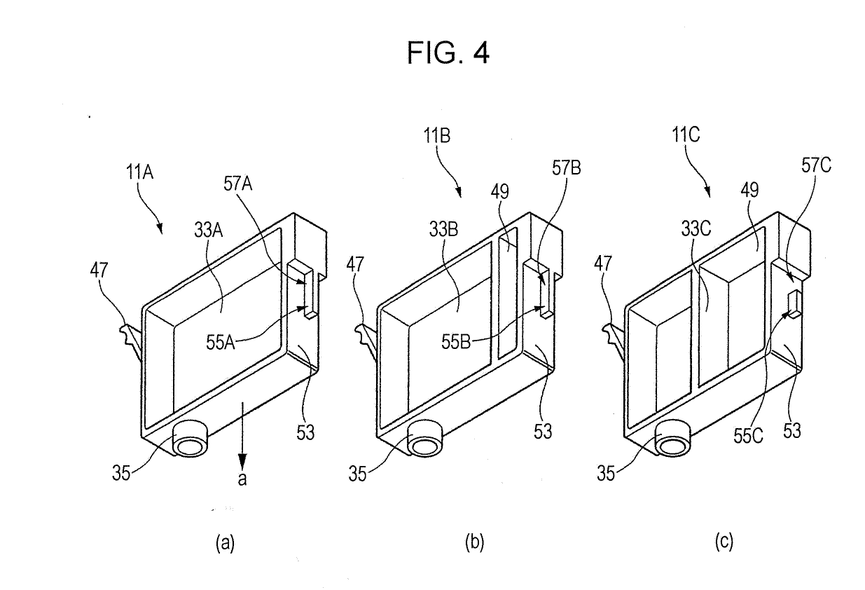

The ink cartridges 11 include, as described in detail below, a large-capacity ink cartridge 11A having a large capacity and containing the ink 50 (refer to FIG. 4), a medium-capacity ink cartridge 11B having a medium capacity and containing the ink 50, and a small-capacity ink cartridge 11C having a small capacity and containing the ink 50, for example. These ink cartridges are categorized into certain groups (for example, a group of the large capacities and a group of the medium and small capacities), and can be mounted only to the color ink jet printer 13 of a predetermined model.

Next, a schematic configuration of the ink cartridge 11 will be described.

As shown in FIG. 2, each of the ink cartridges 11 has a container body 31 including a liquid containing section 33 that contains the ink 50, an ink supply section 35 to be connected to the print head 21, and an air communicating hole 37 that introduces air into the liquid containing section 33 from outside as the ink in the liquid containing section 33 is consumed.

A film 41a is affixed to a front opening 39 of the container body 31 and a film 41b is affixed to a back opening 43 of the container body 31. These films 41a and 41b seal the front and back openings 39 and 43 of the container body 31, respectively, to define the liquid containing section 33. A cover 45 is fixedly attached to the front surface of the container body 31 sealed with the film 41a.

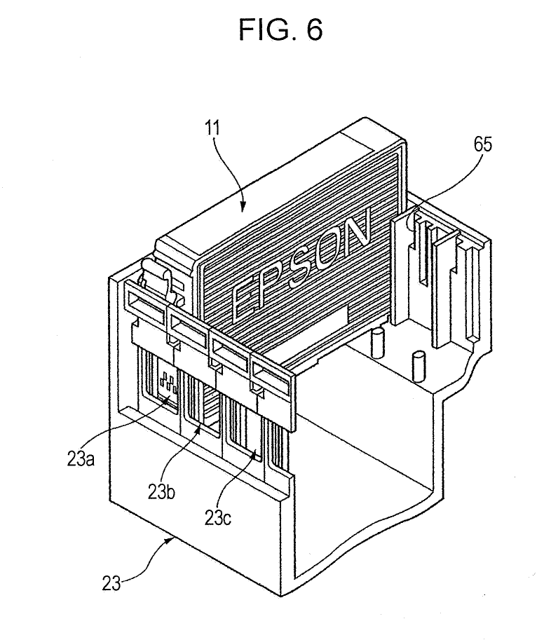

Each of the ink cartridges 11 according to the embodiment has a lever 47 used for fitting/removing the ink cartridge 11 in/from any of cartridge receptacles 23a, 23b, and 23c of the carriage 23 (refer to FIG. 6), a bearing-plate storage section, and a pressure control means (not shown) including a coil spring and a bearing plate.

As shown in FIG. 3, the container bodies 31 constituting the liquid containing sections 33 of the ink cartridges 11 include container bodies 31A, 31B, and 31C having different tank volumes corresponding to the capacities of the ink 50. The container bodies 31B and 31C used for the medium-capacity and small-capacity ink cartridges 11B and 11C, respectively, whose ink capacities are small, have partition walls 49 and 51 that make the capacities of the liquid containing sections 33B and 33c smaller than that of the liquid containing section 33A of the large-capacity ink cartridge 11A.

If the container body 31 capable of containing a 10 ml of ink 50 contains only a 5 ml of ink, for example, a large volume of air exists in the liquid containing section 33. When the container body 31 is subjected to vibration during transportation or the like, the large volume of air dissolves in the ink, which may degrade a vacuum of the container body 31 and adversely affect printing reliability.

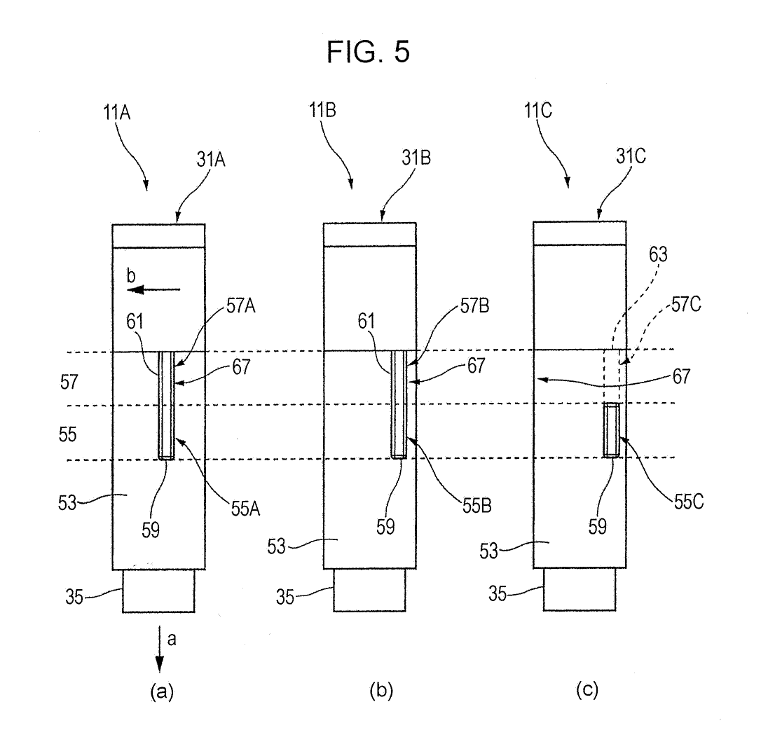

FIGS. 4(a), 4(b), and 4(c) are back views of exemplary liquid containers having different determination portions. FIGS. 5(a), 5(b), and 5(c) are schematic views of exemplary formations of determination portions.

As shown in FIG. 5, the container bodies 31A, 31B, and 31C each have a side face (in the embodiment, back face 53) parallel to a fitting direction (arrow a direction) of the container bodies 31A, 31B, and 31C. Each of the container bodies 31A, 31B, and 31C includes a fittingness-determination portion 55 that extends in the fitting direction and enables fittingness determination depending on a position thereof in a direction (arrow b direction) perpendicular to the fitting direction; and a filling-determination portion 57 that is formed at the fittingness-determination portion 55 and enables determination of the amount of the ink 50 to be filled in the container bodies 31A, 31B, and 31C. The fittingness-determination portion 55 and the filling-determination portion 57 are formed on a single area of the side face. The fittingness-determination portion 55 constitutes a ridge (rib shape) 59 extending in the fitting direction.

A position of a fittingness-determination portion 55A disposed on the large-capacity ink cartridge 11A is different from positions of fittingness-determination portions 55B and 55B disposed on the medium-capacity and small-capacity ink cartridges 11B and 11C, respectively. The fittingness-determination portion 55A is disposed on the left side of the back face 53, and the fittingness-determination portions 55B and 55B are disposed on the right side of the back face 53.

Further, the filling-determination portion 57 may constitute a ridge 61 or a cutaway portion 63. The filling-determination portion 57A provided on the large-capacity ink cartridge 11A constitutes the ridge 61 extended to the posterior end in the fitting direction of the fittingness-determination portion 55A. The filling-determination portion 57B provided on the medium-capacity ink cartridge 11B also constitutes the ridge 61 extended to the posterior end in the fitting direction of the fittingness-determination portion 55B. The filling-determination portion 57C provided on the small-capacity ink cartridge 11C constitutes, however, the cutaway portion 63 provided at the posterior end in the fitting direction of the fittingness-determination portion 55B.

In the embodiment, the fittingness-determination portion 55 and the filling-determination portion 57C are described as separate portions. However, the fittingness-determination portion 55 and the filling-determination portion 57C may be regarded as the integrally formed ridges 59 and 61. In that case, the fittingness-determination portions 55A and 55B, and the filling-determination portions 57A and 57B provided on the large-capacity and medium-capacity ink cartridges 11A and 11B, respectively, may be regarded as the integrally formed ridges 59 and 61.

In contrast, the filling-determination portion 57C of the small-capacity ink cartridge 11C may be regarded as the cutaway portion 63 formed by removing the ridge 61 that should have been extended to the fittingness-determination portion 55B. Accordingly, the invention includes technical ideas of both cases.

As described above, in the case of the filling-determination portion 57C constituting the cutaway portion 63, the filling-determination portion 57C can be formed by removing the posterior end (namely, the ridge 61) in the fitting direction of the fittingness-determination portion including the ridges 59 and 61. The anterior end (ridge 59) in the fitting direction remains. Because only the posterior end is removed, the determination function of the fittingness-determination portion 55B will not be degraded. Further, in this case, by changing the amount of removal from the posterior end to the anterior end, it becomes easy to further increase the patterns of determination performed by the filling-determination portion 57C.

FIG. 6 is a partially cutaway perspective view of a carriage shown in FIG. 1, in which only one ink cartridge is mounted.

When predetermined ink cartridges 11 are about to be mounted on the plurality of cartridge receptacles (container receptacles) 23a, 23b, and 23c formed in the carriage 23, the fittingness-determination portions 55 prevent the ink cartridges 11 from being improperly inserted into the cartridge receptacles 23a, 23b, and 23c.

The ink cartridges 11 are prevented from being improperly inserted into the cartridge receptacles 23a, 23b, and 23c by the fittingness-determination portions 55 being mounted onto the predetermined fitting grooves 65 provided in the cartridge receptacles 23a, 23b and 23c.

The ink cartridges 11 configured as above have the fittingness-determination portions 55 constituting the ridges 59. When the container bodies 31A, 31B, and 31C are about to be improperly mounted on the cartridge receptacles 23a, 23b, and 23c, the anterior ends of the fittingness-determination portions 55 abut onto inner walls of the fitting grooves 65 provided in the cartridge receptacles 23a, 23b, and 23c and receive reaction force. However, because the fittingness-determination portions 55 are provided so as to extend in the insertion direction, the strength against the reaction force applied at that time can be increased, whereby damages thereto can be suppressed.

Further, when the filling-determination portion 57C is formed by removing a part of the fittingness-determination portion, a change in the shape of the cartridge receptacles 23a, 23b, and 23c, which becomes necessary in the case of forming a projected filling-determination portion, for example, is not needed. Accordingly, a good fitting property can be maintained. Further, the shape for forming the filling-determination portion 57C needed to be formed on the inset of the mold can be simplified. That is, because the cutaway portion 63 is formed, the inset of the mold has a simple shape in which the inset fills a part for forming the groove that forms the ridge 61.

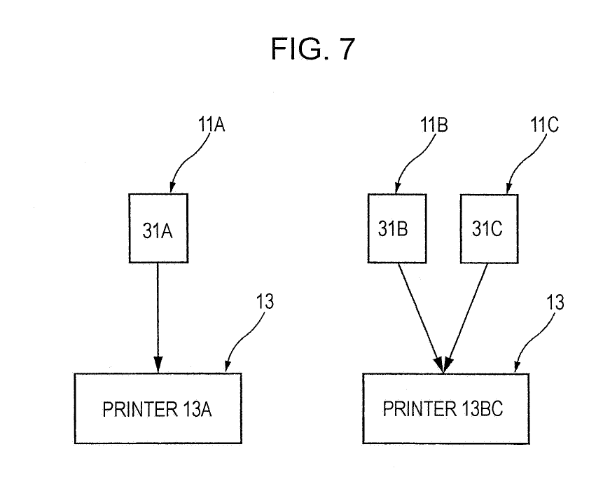

FIG. 7 illustrates relationships between liquid containers and corresponding apparatuses to be mounted with the liquid containers.

In the above-described ink cartridges 11, when there are products having the same misinsertion preventing shape (fittingness-determination portion 55B) but different liquid capacities, such as the medium-capacity and small-capacity ink cartridges 11B and 11C, whether liquid is properly filled into the container bodies 31A, 31B, and 31C in the liquid-filling process can be detected by detecting the filling-determination portions 57 formed at the fittingness-determination portions 55 using a sensing light 67 (refer to FIG. 5) emitted from an optical sensor.

The filling-determination portions 57 are used for setting the ink cartridges 11 with appropriate capacities in an ink filling apparatus, because if, for example, the large-capacity cartridge 11A is set in the ink filling apparatus for the medium-capacity ink cartridge 11B mistakenly, a large volume of air exists in the liquid containing section 33A, which may degrade the vacuum and adversely affect printing reliability. In other words, the filling-determination portions 57 enable determination of whether the ink cartridges 11 with appropriate capacities are set in the ink filling apparatus by optically detecting the ridges 61 of the filling-determination portions 57 with the optical sensor or the like, or by detecting the presence/absence of the ridges 61 with a contact switch or the like.

The above-described determination performed during filling of ink into the ink cartridges 11 is performed not only during manufacturing of the ink cartridges 11, but also during the refilling of ink into the used ink cartridges 11 collected by users.

For example, it is difficult to confirm the capacity of the liquid containing section 33 by disassembling a part of the ink cartridges 11 collected from different users. This results in a low yield rate in recycling. So, whether the ink cartridges 11 with appropriate capacities are set in an ink filling apparatus needs to be determined during refilling of the cartridges, as well as during manufacturing thereof. By using the filling-determination portion 57 also during the refilling of the cartridges with ink, the capacities of the ink cartridges 11 can be easily determined, and whether the ink cartridges 11 with appropriate capacities are set in the ink filling apparatus can be determined.

Further, the liquid containers 11 can be manufactured in different capacities using a single mold by replacing only the inset portion. By integrally forming the fittingness-determination portion 55 and the filling-determination portion 57, these determination portions can be formed on a small single area, and all patterns of the determination portions can be formed by replacing the small inset portion of the mold.

As shown in FIG. 7, by determining fittingness between the container bodies 31A, 31B, and 31C and the color ink jet printers 13A and 13BC, the plurality of types of container bodies 31A, 31B, and 31C can be categorized into the liquid container body 31A appropriate for a specific color ink jet printer 13A and the liquid container bodies 31B and 31C appropriate for another liquid ejecting apparatus 13BC (that is, allocation of a liquid container to an appropriate liquid ejecting apparatus becomes possible).

In the ink cartridges 11 according to the embodiment, the container bodies 31A, 31B, and 31C each have the back face 53 parallel to the fitting direction of the container bodies 31A, 31B, and 31C. Each of the container bodies 31A, 31B, and 31C includes the fittingness-determination portion 55 that extends in the fitting direction and enables fittingness determination depending on a position thereof in the direction perpendicular to the fitting direction; and a filling-determination portion 57 that is formed at the fittingness-determination portion 55 and enables determination of the amount of the liquid to be filled in the container bodies 31A, 31B, and 31C. Therefore, when there are products having the same misinsertion preventing shapes (fittingness-determination portions 55) but different liquid capacities, whether ink is filled into the correct container bodies 31A, 31B, and 31C in the ink-filling process can be determined using the filling-determination portions 57 formed on the fittingness-determination portions 55.

Further, because the fittingness-determination portion 55 and the filling-determination portion 57 are integrally formed, these determination portions can be formed on a small single area, and all patterns of the determination portions can be formed with the small inset portion of the mold. This can simplify the mold structure, reduce the cost of fabricating molds and product price, and improve the ease of maintenance of the mold.

The above-described embodiment is described taking the case where the ink cartridges 11 are to be allocated to different types of the color ink jet printers 13 as an example. However, the liquid containers according to the invention may be of the type in which fittingness between the liquid containers and different container receptacles in a single liquid ejecting apparatus is determined. In that case, the liquid containers are categorized into a plurality of types according to the amount (or color) of liquid contained therein. Then, the plurality of types of liquid containers can be categorized into liquid containers appropriate for a specific container receptacle of a liquid ejecting apparatus and liquid containers appropriate for another container receptacle (that is, allocation of a liquid container to an appropriate container receptacle becomes possible).

1. A liquid container detachably mounted on a liquid ejecting apparatus and having a side face parallel to a fitting direction of the liquid container, the liquid container comprising: a fittingness-determination portion that extends in the fitting direction and enables fittingness determination depending on a position thereof in a direction perpendicular to the fitting direction; and a filling-determination portion that is formed at the fittingness-determination portion and enables determination of the amount of liquid to be filled in the liquid container, the fittingness-determination portion and the filling-determination portion being formed on a single area of the side face.

2. The liquid container according to claim 1, wherein the fittingness-determination portion constitutes a ridge extending in the fitting direction and the filling-determination portion constitutes a cutaway portion provided by removing a part of the fittingness-determination portion.

3. The liquid container according to claim 2, wherein the cutaway portion is formed by removing a posterior end of the fittingness-determination portion in the fitting direction.

4. The liquid container according to claim 1, wherein fittingness between the liquid container and different liquid ejecting apparatuses is determined.

5. The liquid container according to claim 1, wherein fittingness between the liquid container and different container receptacles of a single liquid ejecting apparatus is determined.
